(19) United States
(12) Patent Application Publication
(10) Pub. No.: US 2017/0263393 A1
(43) Pub. Date: Sep. 14, 2017

(54) LIMIT SWITCH DEVICE

(71) Applicant: OMRON Corporation, Kyoto (JP)

(72) Inventors: Kazuyuki Tsukimori, Okayama (JP); Makito Morii, Okayama (JP); Yuki Yamamoto, Okayama (JP); Ichizo Sakamoto, Shiga (JP)

(73) Assignee: OMRON Corporation, Kyoto (JP)

(21) Appl. No.: 15/378,832

(22) Filed: Dec. 14, 2016

(30) Foreign Application Priority Data
Mar. 9, 2016 (JP) 2016-046126

(51) Int. Cl. H01H 15/14; H01H 3/16

(52) U.S. Cl. CPC H01H 15/14; H01H 3/16

(57) ABSTRACT

A limit switch device is placed at an intended stop position, without the need to move the actuator additionally from the position at which the on/off state is switched. A first movable portion (211) causes a first contact to slide on a second contact in a switch mechanism (103) included in a microswitch by applying a force (F′) via an actuator (102a) and a plunger (102b).

### FIELD

The present invention relates to a limit switch device.

### BACKGROUND

A limit switch device including a microswitch encased in a protective case has been known. The limit switch device is incorporated in, for example, an industrial machine or equipment and is used to detect an object. The internal microswitch of the limit switch device includes a movable contact, a stationary contact, and an operation lever for moving the movable contact. The movable contact moves toward and away from the stationary contact.

Referring now to FIGS. 6A and 6B, the operation of a movable contact and a stationary contact in an opposing-contact limit switch device known in the art will be described. FIGS. 6A and 6B are schematic diagrams showing the operation of a movable contact 12c and stationary contacts 12a and 12b included in an opposing-contact limit switch device. As shown in FIGS. 6A and 6B, the stationary contact 12a, the movable contact 12c, and the stationary contact 12b are arranged in this order in a vertical direction in FIGS. 6A and 6B. The movable contact 12c is supported on an operation lever 2A included in the internal microswitch. The stationary contacts 12a and 12b are not supported on the operation lever 2A and are fixed at predetermined positions in the internal microswitch. When a detection target, such as a workpiece, touches an actuator (not shown) in the limit switch device, the operation lever 2A is forced downward with a plunger (not shown) in the limit switch device. The stationary contact 12a is a normally open (NO) contact, whereas the stationary contact 12b is a normally closed (NC) contact. As shown in FIG. 6A, when the operation lever 2A is receiving no force from the plunger in the limit switch device, the movable contact 12c is in contact with the stationary contact 12b, which is an NC contact.

When the operation lever 2A receives a downward force from the plunger, the movable contact 12c moves upward in FIG. 6A, or in other words, in a direction from the stationary contact 12b toward the stationary contact 12a. Additionally, a spring (not shown) on the operation lever 2A deforms elastically. As shown in FIG. 6B, the movable contact 12c eventually touches the stationary contact 12a. When the force from the plunger is removed, the spring force moves the operation lever 2A upward in FIG. 6B, and the movable contact 12c moves downward in FIG. 6B. The movable contact 12c returns to the position shown in FIG. 6A and touches the stationary contact 12b again.

### CITATION LIST

### Patent Literature

Patent Literature 1: Japanese Unexamined Patent Application Publication No. 2000-003636 (published on Jan. 7, 2000)

### SUMMARY

### Technical Problem

FIG. 7 is a graph showing the relationship between the moved distance of an operation lever (mm) and the contact load (N) in a microswitch included in an opposing-contact limit switch device known in the art. The moved distance (mm) is the distance by which the operation lever of the microswitch moves from a reference position. The reference position is the position of the operation lever of the microswitch under no external force applied on the actuator in the limit switch device. The contact load (N) is the contact pressure between the movable contact and the stationary contact. In the graph shown in FIG. 7, the load on an NC contact is expressed using a positive value, whereas the load on an NO contact is expressed using a negative value.

As shown in FIG. 7, the movable contact is in contact with the NC contact before the actuator in the limit switch device receives an external force, or in other words, before the operation lever of the microswitch starts moving (with a moved distance of 0 mm). When the actuator in the limit switch device receives an external force, the operation lever of the microswitch moves downward in FIG. 6A, while the contact load of the movable contact on the NC contact is decreasing. The movable contact then moves away from the NC contact and then touches the NO contact. This switches the on/off state of the limit switch device.

When the movable contact touches the NO contact, the contact load is low, and the area of contact between the movable contact and the NO contact is small. The contact between these contacts is unstable. The operation lever of the microswitch then moves by a certain distance to cause the movable contact to apply a sufficiently high contact load onto the NO contact. This stabilizes the contact between these contacts.

In this manner, the contact between the movable contact and the stationary contact (NC or NO contact) is unstable before and after the moment when the on/off state of the limit switch device is switched. Thus, the opposing-contact limit switch device known in the art moves the operation lever to a position at which the contact is stable between the movable contact and the stationary contact, or more specifically, the actuator is moved by an additional distance from the position at which the on/off state of the limit switch device is switched.

For example, a limit switch device used for detecting the position of an elevator in a multi-story car park will now be described.

In a multi-story car park, automobiles are parked side by side on each of multiple stories. The elevator carrying an automobile moves up and down and stops at a predetermined position, as the position of the elevator is controlled by using a limit switch device. The elevator carrying an automobile is to stop at the same position every time. However, the opposing-contact limit switch device known in the art moves its actuator by an additional distance from the position at which the on/off state of the limit switch device is switched, and thus is placed at a position slightly preceding an intended stop position.

In response to this issue, one or more aspects of the present invention are directed to a limit switch device that is placed at an intended stop position, without the need to move the actuator from the position at which the on/off state is switched.

### Solution to Problem

In response to the above issue, a limit switch device according to one aspect of the present invention includes an actuator that moves in accordance with a load from an external detection target, a plunger that moves vertically upon receiving movement of the actuator, a movable portion that moves in accordance with vertical movement of the plunger, and a first contact and a second contact. The first contact is arranged in the movable portion. The first contact and the second contact switch between a state of no electrical contact between the first contact and the second contact and a state of the first contact being moved by the movable portion and sliding on a surface of the second contact in a direction in which the first contact is moved. Sliding includes smoothly moving on a surface while being maintained in contact with the surface, and includes moving on a surface under a contact pressure while being maintained in contact with the surface.

In this structure, the first contact and the second contact are switched between the state of not being in contact with each other and the state in which the first contact slides on the surface of the second contact in the direction of the movement, and thus the contact between the first contact and the second contact is stable under a predetermined contact pressure applied between the contacts immediately after the first contact touches the second contact. This provides a limit switch device that can be placed at an intended stop position, without the need to move the actuator from the position at which the on/off state is switched.

In the above structure having one contact sliding on another, such sliding can remove any foreign substance on the contacts. The above structure thus provides a limit switch device less susceptible to the surroundings than the opposing-contact limit switch device known in the art.

In the limit switch device according to another aspect of the present invention, the direction in which the first contact is moved by the movable portion is substantially orthogonal to a direction of a contact pressure applied between the first contact and the second contact.

In this structure, the first contact slides on the second contact while these contacts are maintained firmly in contact with each other under a contact pressure constantly applied in a direction substantially orthogonal to the moving direction of the first contact, independently of the moved distance.

The limit switch device according to another aspect of the present invention further includes a support that supports at least one of the first contact or the second contact. The support is formed from an elastic member. When the first contact slides on the surface of the second contact, the support applies an elastic force to place the first contact into dose contact with the second contact.

In this structure, the support applies an elastic force to cause the first contact to come in dose contact with the second contact. This maintains at least a predetermined contact pressure between the first contact and the second contact in a stable manner.

In the limit switch device according to another aspect of the present invention, the second contact has a first surface and a second surface opposite to the first surface. The first contact includes a portion that comes hi contact with the first surface and a portion that comes in contact with the second surface.

In this structure, the first contact touches the first surface and the second surface of the second contact. More specifically, the contact between the two contacts is more stable than in the structure having the first contact touching one surface of the second contact. This structure increases the likelihood of the first contact being maintained in contact with at least one of the first and second surfaces of the second contact when, for example, the first contact receives an external force applied in the direction in which the first contact touches the second contact. This provides a limit switch device that is less likely to produce chattering.

In the limit switch device according to another aspect of the present invention, the first contact slides on a sliding surface including the surface of the second contact and a surface of an insulator that are continuous to each other, and the first contact comes in contact with the surface of the second contact or the surface of the insulator.

In this structure, the first contact slides on the slide surface to switch the state of contact between the first contact and the second contact. The second contact surface and the insulator surface are continuous to each other to form the slide surface. This allows a constant load to be applied from the first contact to the slide surface when the contact state is switched. This allows stable switching between these contacts.

The limit switch device according to another aspect of the present invention includes a first housing containing the first contact and the second contact, and a second housing holding the actuator and containing the first housing.

In this structure, the first housing contains the first contact and the second contact. The second housing contains the first housing. The contacts are thus encased in double layers. This structure effectively reduces entry of foreign substances into an area around the contacts.

The actuator that comes in direct contact with the detection target is held by the second housing. This structure reduces a force applied to the contacts when the limit switch device receives an unintended external force. In other words, this provides a limit switch device with high resistance to external impact. At least either the first housing or the second housing may be sealed to prevent entry of foreign substances (e.g., dust) inside.

### Advantageous Effects

The limit switch device according to embodiments of the present invention is placed at an intended stop position, without the need to move the actuator from the position at which the on/off state is switched.

### BRIEF DESCRIPTION OF THE DRAWINGS

FIG. 1A is a cross-sectional view of a limit switch device according to one embodiment, and FIG. 18 is a perspective view showing the appearance of the limit switch device.

FIG. 2 is a diagram showing an example of a limit switch device having a structure different from the limit switch device shown in FIGS. 1A and 1B.

FIG. 3A is a diagram showing the structure of a normally open switch mechanism in a limit switch device according to one embodiment, and FIG. 3B is a diagram showing the structure of a normally closed switch mechanism in the limit switch device according to one embodiment.

FIG. 4 is a diagram showing a switch mechanism having a structure different from the switch mechanism shown in FIGS. 3A and 3B.

FIG. 5 is a perspective view showing the structure of the switch mechanism included in the limit switch device shown in FIG. 2.

FIGS. 6A and 6B are schematic diagrams showing the operation of a movable contact and stationary contacts included in an opposing-contact limit switch device known in the art.

FIG. 7 is a graph showing the relationship between the moved distance of a plunger and the contact load in the opposing-contact limit switch device known in the art.

### DETAILED DESCRIPTION

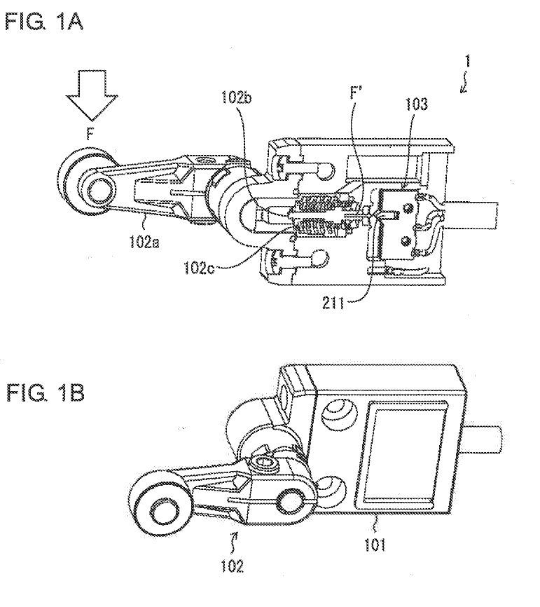

Embodiments of the present invention will now be described in detail with reference to FIGS. 1 to 5.

### Structure of Limit Switch Device 1

The structure of a limit switch device 1 according to the present embodiment will now be described with reference to FIGS. 1A and 1B. FIG. 1A is a cross-sectional view of the limit switch device 1. FIG. 1B is a perspective view showing the appearance of the limit switch device 1. As shown in FIGS. 1A and 1B, the limit switch device 1 includes a protective case 101 (second housing), an operation mechanism 102, and a switch mechanism 103. The switch mechanism 103 includes a first movable portion 211 (movable portion). As shown in FIG. 1A, the operation mechanism 102 includes an actuator 102a, a plunger 102b, and a spring 102c.

The limit switch device 1 includes a first housing containing the switch mechanism 103 (refer to FIG. 1A), which is contained in the second housing (protective case 101). As shown in FIG. 1A, the limit switch device 1 includes (i) the actuator 102a, which moves when touching an object (detection target) and transfers its movement to the plunger 102b included in the operation mechanism 102, (ii) the first housing containing the switch mechanism 103, and (iii) the second housing (protective case 101) holding the actuator 102a and containing the first housing. The limit switch device 1 is, for example, used as a sensor for positioning as well as detecting an object in manufacturing equipment or an industrial machine.

The protective case 101 shown in FIG. 1B protects the switch mechanism 103 from external force, water, oil, gas, and dust. The protective case 101 may be formed from, for example, metals such as aluminum die-cast and zinc die-cast alloys. To seal gaps in the protective case 101, a sealant containing silicone rubber may be used. Silicone rubber has high heat resistance (200° C.), weather resistance, and cold resistance (70 to −80°C.). Silicone rubber also has oil resistance. Thus, silicone rubber is useful for the limit switch device 1 placed in an environment with temperatures of, for example, −40 to −60°C., such as an ultra-low temperature room.

As shown in FIG. 1A, when a detection target object touches the actuator 102a in the operation mechanism 102, the actuator 102a rotates about its pivot under an external force F shown in FIG. 1. The rotational motion of the pivot along with the rotation of the actuator 102a is converted into linear motion, which then moves the plunger 102b in the operation mechanism 102 in a direction of force F′, which is substantially perpendicular to the external force F (to the right in FIG. 1). In accordance with the movement of the plunger 102b, the first movable portion 211 moves in the manner described later.

The switch mechanism 103 opens or closes an electric circuit (not shown) in the limit switch device 1 (in other words, switches the state of contact between a movable contact 103a and a stationary contact 103b described later).

### Example Structure of Switch Mechanism 103

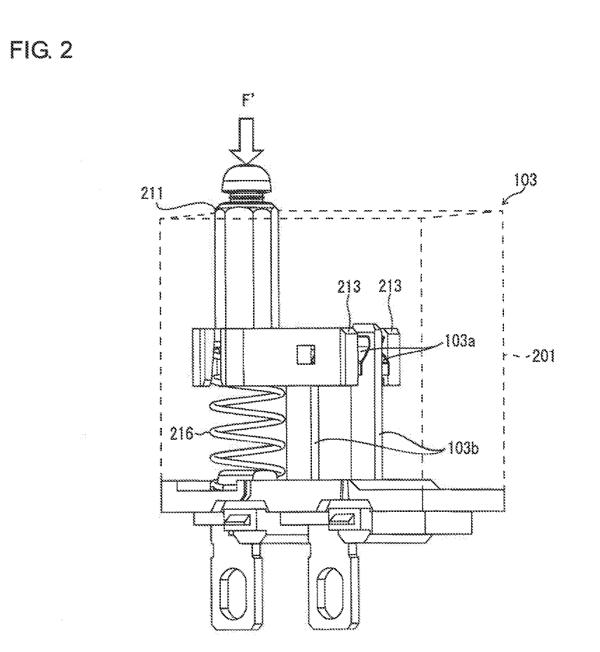

With reference to FIG. 2, the structure of the switch mechanism 103 will now be described. FIG. 2 is a perspective view showing the structure of the switch mechanism 103.

As shown in FIG. 2, the switch mechanism 103 includes the first movable portion 211, the movable contact 103a (first contact), a second movable portion 213 (movable portion), and the stationary contact 103b (second contact). The switch mechanism 103 is contained in a first housing 201. The first housing 201 holds the first movable portion 211. In the switch mechanism 103, the second movable portion 213 supports the movable contact 103a. The movable contact 103a has its elastically deformable part (support) bending, and thus is pressed against the stationary contact 103b. This produces a sufficiently high contact pressure applied in a direction substantially perpendicular to the direction of the force F′ between the movable contact 103a and the stationary contact 103b. The contact between the movable contact 103a and the stationary contact 103b is thus constantly stable.

The movable contact 103a and the stationary contact 103b are formed from conductive materials (e.g., metals). The movable contact 103a may include one or more portions.

The first movable portion 211 and the second movable portion 213 move in a vertical direction in the figure. The movable contact 103a slides on the surface of the stationary contact 103b. The first movable portion 211 has a spring 216. The spring 216 is compressed when receiving an external force F′. When released from the external force F′, the spring 216 expands back to the original length (the length before the external force F′ is applied). The spring 216 is specifically a coil spring. The spring 216 may be any spring that produces a reaction force, such as a torsion spring.

### Switch Mechanism 103 and Switching

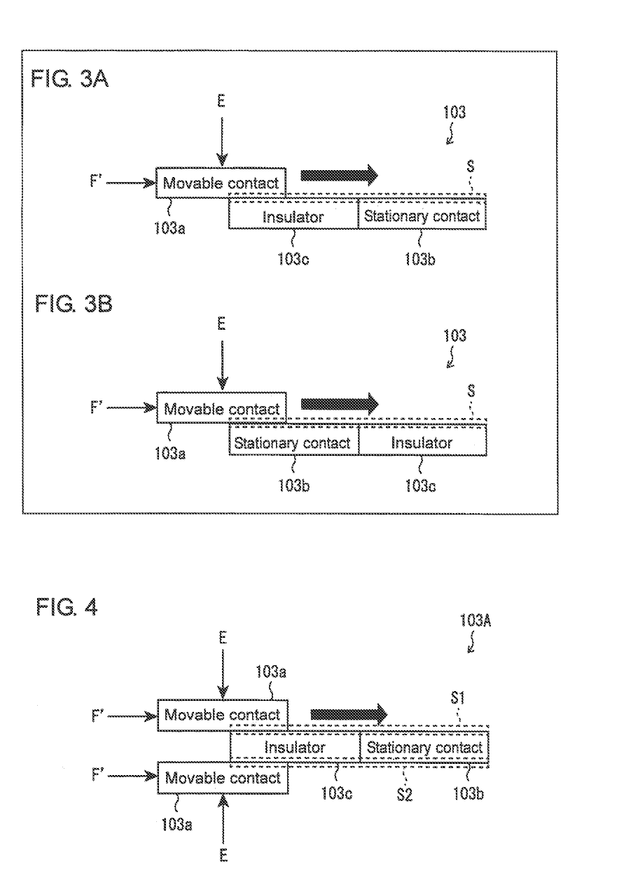

FIGS. 3A, 3B, and 4 are diagrams showing the conceptual structures of the switch mechanism 103, showing the arrangement of the movable contact 103a and the stationary contact 103b. The structure in FIG. 2 corresponds to the conceptual structure shown in FIG. 4.

FIG. 3A shows a normally open (NO) switch mechanism 103 in the limit switch device 1. FIG. 3B shows a normally closed (NC) switch mechanism 103 in the limit switch device 1. The NO switch mechanism 103 shown in FIG. 3A is in an off-state under no force F′. The NC switch mechanism 103 shown in FIG. 36 is in an on-state under no force F′.

As shown in FIGS. 3A and 3B, the stationary contact 103b connects with the insulator 103c in the switch mechanism 103. The contact surface of the stationary contact 103b and the surface of the insulator 103c form a flat slide surface S. The insulator 103c may be formed from any insulating material.

The movable contact 103a is pressed against the slide surface S under a downward elastic force E (in a direction toward the slide surface S) applied from the support (e.g., a portion formed from an elastic member, such as the elastically deformable part of the movable contact 103a shown in FIG. 2). When the operation mechanism 102 is under the downward external force F (in a direction in which the operation mechanism 102 moves) in FIG. 1, the movable contact 103a receives a rightward force F′ (in a direction parallel to the slide surface S) applied from the operation mechanism 102. The movable contact 103a thus slides on the slide surface S. In this manner, the movable contact 103a moves in a direction parallel to the slide surface S of the stationary contact 103b (and the insulator 103c).

In the NO switch mechanism 103 shown in FIG. 3A, the movable contact 103a is not in contact with the stationary contact 103b and is in contact with the insulator 103c when the operation mechanism 102 is under no external force F. In other words, the limit switch device 1 is in an off-state. When the operation mechanism 102 receives a downward external force F (refer to FIG. 1A), the movable contact 103a receives a rightward force F′ (in a direction substantially perpendicular to the direction of the external force F). When the operation mechanism 102 is under the downward external force F, the spring 102c included in the operation mechanism 102 is compressed. The movable contact 103a slides toward the stationary contact 103b while being maintained in contact with the slide surface S under the rightward force F′. When the movable contact 103a touches the stationary contact 103b, the limit switch device 1 is turned on. In the NC switch mechanism 103 (FIG. 3B), the force F′ applied on the switch mechanism 103 turns off the limit switch device 1.

When the external force F on the operation mechanism 102 is removed, the elastic force of the spring 102c causes the operation mechanism 102 to return to the state before the external force F is applied. The movable contact 103a also returns to the state before the force F′ is applied by the spring 216. In the NO switch mechanism 103 (FIG. 3A), the movable contact 103a returns to the state of being in contact with only the insulator 103c. When the movable contact 103a is no longer in contact with the stationary contact 103b, the limit switch device 1 returns to the off-state. In the NC switch mechanism 103 (FIG. 3B), the movable contact 103a returns to the state of being in contact with only the stationary contact 103b. The limit switch device 1 returns to the on-state.

As shown in FIGS. 3A and 3B, the surface of the stationary contact 103b and the surface of the insulator 103c, which form the slide surface S, are continuous to each other. While the movable contact 103a is sliding on the slide surface S, the support applies the elastic force E to the movable contact 103a in a direction orthogonal to the direction in which the movable contact 103a moves. This force presses the movable contact 103a against the slide surface S, and causes the movable contact 103a to apply a constant load onto the slide surface S. The limit switch device 1 can switch between the contacts in a stable manner.

### Modification of Switch Mechanism 103

A modification of the switch mechanism 103 described above will now be described with reference to FIG. 4. FIG. 4 is a diagram showing the structure of a switch mechanism 103A according to this modification. As shown in FIG. 4, the switch mechanism 103A includes a movable contact 103a including two portions. The two portions of the movable contact 103a are arranged in contact with a first slide surface S1 (first surface) formed by a stationary contact 103b and an insulator 103c and with a second slide surface S2 (second surface) opposite to the first slide surface S1. The two portions of the movable contact 103a are pressed against the first slide surface S1 and the second slide surface S2 under an elastic force E applied from a support. The movable contact 103a in the switch mechanism 103A includes one portion that comes in contact with the first slide surface S1 and the other portion that comes in contact with the second slide surface S2. The portion of the movable contact 103a that comes in contact with the first slide surface S1 slides on the first slide surface S1, whereas the portion of the movable contacts 103a that comes in contact with the second slide surface S2 slides on the second slide surface S2.

In this manner, the movable contact 103a according to this modification comes in contact with both the first slide surface S1 of the stationary contact 103b and the second slide surface S2 opposite to the first slide surface S1. This structure improves the stability of contact between the movable contact 103a and the stationary contact 103b. When, for example, the limit switch device 1 receives an external force as a disturbance factor, the movable contact 103a is highly likely to remain in contact with at least one of the first slide surface S1 and the second slide surface S2 of the stationary contact 103b. The limit switch device 1 is less likely to produce chattering.

### Other Embodiments of Switch Mechanism 103

The switch mechanism 103 shown in FIGS. 3A, 3B, and 4 includes the movable contact 103a, the stationary contact 103b, and the insulator 103c. However, the switch mechanism according to embodiments of the present invention may not include the insulator 103c. A switch mechanism according another embodiment of the present invention will now be described.

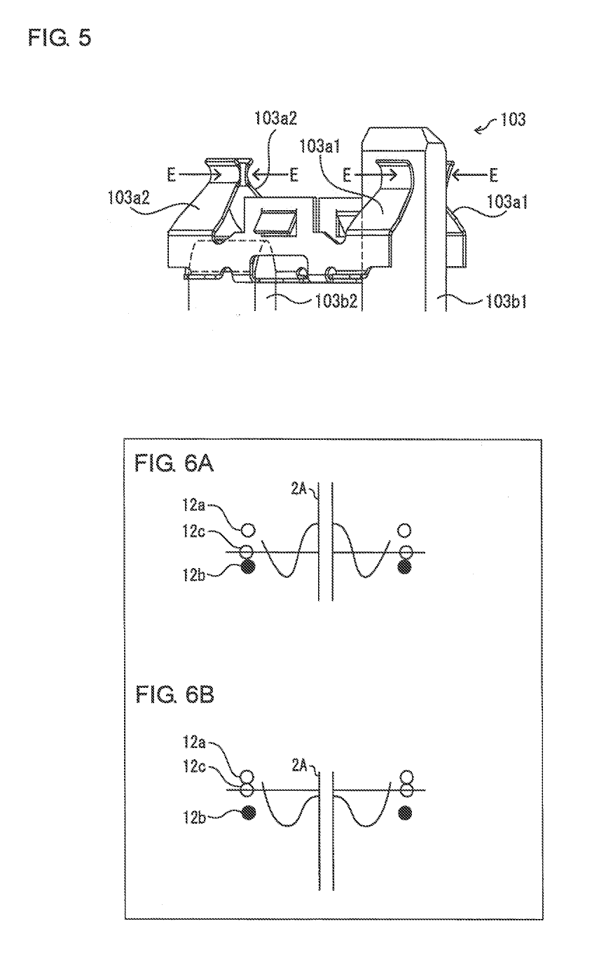

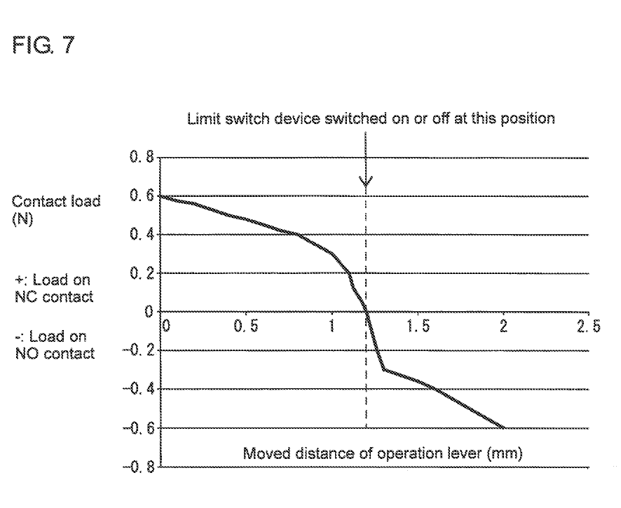

FIG. 5 is a diagram showing the structure of a switch mechanism 103 according to another embodiment. As shown in FIG. 5, the switch mechanism 103 includes a stationary contact 103b including a first stationary contact 103b1 and a second stationary contact 103b2. The movable contact 103a includes a first movable contact 103a1 that slides on the first stationary contact 103b1 and a second movable contact 103a2 that slides on the second stationary contact 103b2.

In FIG. 5, the first movable contact 103a1 is in contact with the first stationary contact 103b1. The second movable contact 103a2 is not in contact with the second stationary contact 103b2. The first movable contact 103a1 and the second movable contact 103a2 move vertically in FIG. 5. The switch mechanism 103 shown in FIG. 5 can thus be in one of the two states below.

(1) The first movable contact 103a1 is in contact with the first stationary contact 103b1, and the second movable contact 103a2 is spaced from the second stationary contact 103b2.

(2) The first movable contact 103a1 is in contact with the first stationary contact 103b1, and the second movable contact 103a2 is also in contact with the second stationary contact 103b2.

The second movable contact 103a2 includes elastic parts that can touch the second stationary contact 103b2. When in contact with the second stationary contact 103b2, the second movable contact 103a2 is pressed against the second stationary contact 103b2 under the elastic force E applied from the elastic parts. Thus, immediately after the second movable contact 103a2 and the second stationary contact 103b2 spaced from each other come in contact with each other, these contacts receive a sufficiently high contact pressure, and have a large area of contact between them. Immediately before the second movable contact 103a2 and the second stationary contact 103b2 in contact with each other are spaced from each other, these contacts receive a sufficiently high contact pressure, and have a large area of contact between them. In other words, the contact between the second movable contact 103a2 and the second stationary contact 103b2 is constantly stable.

When in contact with the first stationary contact 103b1, the first movable contact 103a1 is also pressed against the first stationary contact 103b1 under the elastic force E applied from the elastic parts of the first movable contact 103a1. The contact between the first movable contact 103a1 and the first stationary contact 103b1 is also constantly stable.

As described above, the switch mechanism 103 according to the present embodiment has its elastic support applying the elastic force E to the movable contact 103a in a direction orthogonal to the direction in which the movable contact 103a moves. This produces a constant contact load applied between the movable contact 103a and the stationary contact 103b or the insulator 103c in a stable manner. The limit switch device 1 including the switch mechanism 103 can thus be placed at any intended stop position, without the need to move the actuator 102a from the position at which the on/off state is switched. For example, the limit switch device 1 may be placed at an intended stop position at which an automobile is to be stopped in a multi-story car park.

In the limit switch device 1, the movable contact 103a slides on the stationary contact 103b to remove any foreign substance on the movable contact 103a or on the stationary contact 103b. Thus, the limit switch device 1 according to the present embodiment is less susceptible to the surroundings. For example, silicone rubber used as a sealant for sealing gaps in the protective case can create an atmosphere of silicone inside the protective case, and silicone can adhere to the movable contact 103a and the stationary contact 103b. In the limit switch device 1 according to the present embodiment, the movable contact 103a and the stationary contact 103b slide and wipe out the silicone adhering to the movable contact 103a and the stationary contact 103b. Thus, the limit switch device 1 improves the stability of contact between the movable contact 103a and the stationary contact 103b.

### REFERENCE SIGNS LIST

1 limit switch device
101 protective case (second housing)
102 operation mechanism
102a actuator
102b plunger
103a movable contact (first contact)
103b stationary contact (second contact)
201 first housing
211 first movable portion (movable portion)
213 second movable portion (movable portion)
S slide surface
S1 first slide surface (first surface)
S2 second slide surface (second surface)

1. A limit switch device, comprising:
an actuator configured to move in accordance with a load from an external detection target;
a plunger configured to move vertically upon receiving movement of the actuator;
a movable portion configured to move in accordance with vertical movement of the plunger; and
a first contact and a second contact,
the first contact being arranged in the movable portion,
the first contact and the second contact being configured to switch between a state of no electrical contact between the first contact and the second contact and a state of the first contact being moved by the movable portion and sliding on a surface of the second contact in a direction in which the first contact is moved.

2. The limit switch device according to claim 1, wherein
the direction in which the first contact is moved by the movable portion is substantially orthogonal to a direction of a contact pressure applied between the first contact and the second contact.

3. The limit switch device according to claim 1, further comprising:
a support configured to support at least one of the first contact or the second contact,
wherein the support comprises an elastic member, and
when the first contact slides on the surface of the second contact, the support applies an elastic force to place the first contact into close contact with the second contact.

4. The limit switch device according to claim 2, further comprising:
a support configured to support at least one of the first contact or the second contact,
wherein the support comprises an elastic member, and
when the first contact slides on the surface of the second contact, the support applies an elastic force to place the first contact into close contact with the second contact.

5. The limit switch device according to claim 1, wherein
the second contact has a first surface and a second surface opposite to the first surface, and
the first contact includes a portion configured to come in contact with the first surface and a portion configured to come in contact with the second surface.

6. The limit switch device according to claim 2, wherein
the second contact has a first surface and a second surface opposite to the first surface, and
the first contact includes a portion configured to come in contact with the first surface and a portion configured to come in contact with the second surface.

7. The limit switch device according to claim 3, wherein
the second contact has a first surface and a second surface opposite to the first surface, and
the first contact includes a portion configured to come in contact with the first surface and a portion configured to come in contact with the second surface.

8. The limit switch device according to claim 4, wherein
the second contact has a first surface and a second surface opposite to the first surface, and
the first contact includes a portion configured to come in contact with the first surface and a portion configured to come in contact with the second surface

9. The limit switch device according to claim 1, wherein
the first contact slides on a sliding surface comprising the surface of the second contact and a surface of an insulator that are continuous to each other, and
the first contact is configured to come in contact with the surface of the second contact or the surface of the insulator.

10. The limit switch device according to claim 1, further comprising:
a first housing containing the first contact and the second contact; and
a second housing holding the actuator and containing the first housing.
